(19) United States
(12) Patent Application Publication
(10) Pub. No.: US 2022/0229430 A1
(43) Pub. Date: Jul. 21, 2022

(54) SYSTEM AND METHOD FOR CAUSE AND EFFECT ANALYSIS OF ANOMALY DETECTION APPLICATIONS

(71) Applicant: Noodle Analytics, Inc., San Francisco, CA (US)

(72) Inventors: Ravishankar BALASUBRAMANIAN, Bengaluru (IN); Ravikant, Rajasthan (IN)

(21) Appl. No.: 17/246,390

(22) Filed: Apr. 30, 2021

(30) Foreign Application Priority Data
Jan. 19, 2021 (IN) 202141002333

(51) Int. Cl. G05B 23/02; G06F 16/23

(52) U.S. Cl. CPC G05B 23/0245; G05B 2223/06; G06F 16/2379

(57) ABSTRACT

A system for cause and effect analysis for unsupervised anomaly detection is provided. The system accesses a connected system having a plurality of production and/or process lines. Each production line includes a plurality of operational assets. The processor is configured to access scheduling and production data corresponding to a plurality of products manufactured in each of the plurality of production lines. The processor is configured to access sensor data and asset configuration data and asset anomaly data corresponding to each of the plurality of operational assets. The processor is configured to analyze the sensor data, asset configuration data and asset anomaly data for each of the plurality of operational assets to generate an anomaly graph representation. The processor is configured to determine one or more anomalies and/or deviating events for the plurality of operational assets and associated causal inferences for the one or more anomalies and/or deviating events based on the generated anomaly graph representation.

### PRIORITY STATEMENT

The present application claims priority under 35 U.S.C. § 119 to Indian provisional patent application number 202141002333 filed on Jan. 19, 2021 the entire contents of which are hereby incorporated herein by reference.

### BACKGROUND

Embodiments of the present invention generally relate to smart surveillance systems and methods for monitoring assets in connected systems, and more particularly to, techniques for cause and effect analysis of anomaly detection in unsupervised AI applications.

Typical industrial plants are connected systems with inter-dependency of operations between upstream and downstream assets within a processing or a production line. Unplanned downtime within a production or processing line is of concern across these industrial plants, and is often a result of errant behavior of an upstream or downstream equipment. Non-limiting examples of causes for unplanned downtime include failure of critical asset. quality specification of end product in line not being met, input/output specification of component not met in a connected system, operational limits (e.g. process, human-safety, equipment-safety, etc.) outside recommended range, and the like. Unplanned downtime can lead to production loss and/or energy wastage. Conventional methods for identifying a root cause of unplanned downtime involve manual intervention (e.g., by operator, process engineer, maintenance engineer etc.).

Typically, an operator or a process engineer/maintenance engineer determines root cause of the unplanned downtime through process of elimination which is a very tedious and time-consuming process. It is extremely tedious for an operator to determine the causes using deterministic and rules-based processes of elimination that use numerous plots of sensors data from several disparate data repositories. Thus, there is a need for an automated and efficient system for detecting root causes of any unplanned downtime of assets in connected systems.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for cause and effect analysis for unsupervised anomaly detection is provided. The system includes a memory having computer-readable instructions stored therein and a processor configured to execute the computer-readable instructions to access a connected system having a plurality of production and/or process lines. Each of the plurality of production lines and/or process lines includes a plurality of operational assets. The processor is configured to access scheduling and production data corresponding to a plurality of products manufactured in each of the plurality of production lines. The scheduling and production data includes product grades and product dimensions. The processor is configured to access sensor data, asset configuration data and asset anomaly data corresponding to each of the plurality of operational assets. The sensor data is indicative of health of each of the plurality of assets. The processor is configured to analyze the sensor data, asset configuration data and asset anomaly data for each of the plurality of operational assets to generate an anomaly graph representation. The anomaly graph representation provides a cause and effect analysis view for the connected system. The processor is configured to determine one or more anomalies and/or deviating events for the plurality of operational assets and associated causal inferences for the one or more anomalies and/or deviating events based on the generated anomaly graph representation.

According to another example embodiment, a system for cause and effect analysis for unsupervised anomaly detection is provided. The system includes a memory having computer-readable instructions stored therein and a processor configured to execute the computer-readable instructions to detect and evaluate one or more anomalies in a connected system with a plurality of operational assets. The processor includes a monitoring system configured to monitor health of the operational assets across a plurality of production and/or process lines via sensor data received from one or more sensors and an asset data repository configured to store asset configuration data and asset anomaly data corresponding to each of the plurality of operational assets. The processor includes an asset anomaly representation generator configured to analyze the sensor data, asset configuration data and asset anomaly data for each of the plurality of operational assets to generate an anomaly graph representation. The processor also includes an asset anomaly analyzer configured to analyze the anomaly graph representation to determine one or more anomalies and to identify the root causes and associated causal inferences for the one or more anomalies for each of the operational assets.

According to another example embodiment, a computer-implemented method for performing cause and effect analysis for unsupervised anomaly detection is provided. The method includes accessing a connected system having a plurality of production and/or process lines. Each of the plurality of production lines comprises a plurality of operational assets. The method includes receiving sensor data corresponding to each of the plurality of operational assets, the sensor data being indicative of health of each of the plurality of assets. The method further includes accessing asset configuration data and asset anomaly data corresponding to each of the plurality of operational assets and analyzing the sensor data, asset configuration data and asset anomaly data for each of the plurality of operational assets to generate an anomaly graph representation. The anomaly graph representation provides a cause and effect analysis view for the connected system. The method includes determining one or more anomalies and/or deviating events for the plurality of operational assets and associated causal inferences for the one or more anomalies and/or deviating events based on the generated anomaly graph representation.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is an example illustration of an anomaly detection system, according to an example embodiment;

FIG. 2 illustrates an example anomaly detection data chart used by the asset anomaly representation generator of FIG. 1 to generate an anomaly graph representation;

FIG. 3 illustrates example sensor data used by the asset anomaly representation generator of FIG. 1 to generate an anomaly graph representation;

FIG. 4 illustrates an example anomaly graph representation generated by the system of FIG. 1, and

FIG. 5 is a block diagram of an embodiment of a computing device in which the modules of the anomaly detection system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to anomaly detection techniques in connected systems. In particular, the embodiments of the present technique disclose a system that utilizes a systemic cause and effect process to detect anomalies that serve as early warnings for preventing downtimes in such connected systems.

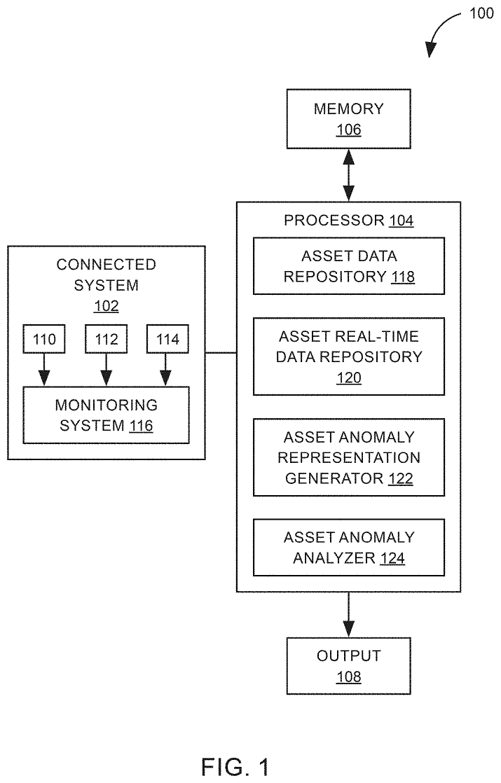

FIG. 1 illustrates a system 100 for cause and effect analysis for unsupervised anomaly detection in accordance with embodiments of the present technique. The anomaly detection system 100 is communicatively coupled to a connected system 102 as illustrated in FIG. 1. The anomaly detection system 100 includes a processor 104, a memory 106 and an output/monitoring module 108. Each component of the system 100 is described in further detail below.

The connected system 102 may be a process-manufacturing enterprise 102 that includes a plurality of production and/or process lines. Each of the plurality of production lines includes a plurality of operational assets such as generally represented by reference numerals 110, 112 and 114 that facilitate operation of the system 102. In some embodiments, the connected system 102 may include a manufacturing plant, a mill, an industrial set up, an assembly line, or combinations thereof. In the illustrated embodiment, there is an inter-dependency of operations between upstream and downstream operational assets 110, 112 and 114. In some embodiments, a cause of unplanned downtime or quality events within the system 102 could be due to errant behavior of an upstream or downstream asset such as 110, 112 and 114.

Referring again to FIG. 1, the memory 106 has computer-readable instructions stored therein, and the processor 104 is configured to execute the computer-readable instructions to monitor the plurality of operational assets 110, 112 and 114, as described in detail below. The connected system 102 may include a monitoring system 116 to receive sensor data corresponding to each of the plurality of assets 110, 112 and 114 within a plurality of production and/or process lines of the system 102, wherein the sensor data is indicative of health of each of the plurality of assets 110, 112 and 114.

The processor 104 includes an asset data repository 118, an asset real-time data repository 120, an asset anomaly representation generator 122 and an asset anomaly analyzer 124.

The processor 104 is configured to execute the computer-readable instructions to monitor the health of the plurality of operational assets 110, 112 and 114 and to perform a cause and effect analysis using a plurality of inputs to detect any unplanned downtime of the assets 110, 112 and 114. In this embodiment, the processor 104 is configured to detect and evaluate one or more anomalies in the connected system 102.

The asset data repository 118 is configured to store asset configuration data related to each of the assets 110, 112 and 114. Such data may include asset hierarchy that includes details about each asset, lines, components in the respective asset and so forth. The asset data repository 118 further includes scheduling and production data corresponding to a plurality of products (not shown) manufactured in each of the plurality of production lines. In certain embodiments, the asset configuration data includes details of specific product type being produced at a specific time, grade and quality specifications of the product type, dimensions or geometry of the product, any change pattern in values of product type, grade or quality specifications, product dimensions, or combinations thereof.

In one example, the scheduling and production data includes product grades and product dimensions. The asset data repository 118 may also include data related to a variety of anomalies such as an anomaly type, start and end times of the anomaly, duration of the anomaly, an anomaly score and so forth.

The asset real time data repository 120 receives and stores real time data about each of the assets 110, 112 and 114 such as being monitored by the monitoring system 116. For example, the asset real time data repository 120 may include sensor data corresponding to each of the operational states of the assets 110, 112 and 114. The sensor data is indicative of health of each of the operational states of the assets 110, 112 and 114. Such data may be received via categorical and non-categorical signals. The signals may be representative of a change trigger, a change percentage or other change values. Other data may include product specification data such as data related to specific product grade being produced at a specific time, any change pattern in the values, product dimensions, and so forth. Based on a type of the connected system 102 and products manufactured in the system 102, a variety of data may be monitored and stored.

The data in the asset data repository 118 further includes anomaly data such as anomaly across components like trigger for multiple anomalies within a window, locations of the anomalies including list of components showing anomalous behaviour at same time with configurable overlap window, trigger for multiple anomalies, locations and list of components showing anomalous behaviour prior to current anomaly time start time and so forth. The asset real time data may also include sensor behavior data such as information related to sensor name, sensor contribution, sensor value change percentage, peak to peak change (max-min) change percentage, percentile with respect to historic data for this sensor, among others.

The asset anomaly representation generator 122 is configured to analyze the data received from the asset data repository 118 and the asset real-time data repository 120 and to systematically create an anomaly graph representation that provides unique cause and effect analysis view for unsupervised anomaly detection for the system 102. Here, the asset anomaly representation generator 122 is configured to analyze the sensor data, asset configuration data and asset anomaly data for each of the plurality of operational assets 110, 112 and 114 to generate the anomaly graph representation. In this embodiment, the asset anomaly representation generator 122 combines anomaly detection, unsupervised clustering, network knowledge graphs, dynamic time warping and process flow approaches such as used in manufacturing industries to provide an intuitive representation to determine and evaluate anomalies through an anomaly graph.

In this example, the asset anomaly representation generator 122 is configured to generate the anomaly graph representation based upon an asset hierarchy, asset information of the plurality of operational assets, information corresponding to associated process/production lines, production scheduling information corresponding to associated product types, product grades or quality specifications, product geometries, product dimensions or combinations thereof.

In this embodiment, the asset anomaly representation generator 122 is configured to analyze an anomaly type, start and end times of an anomaly, duration of an anomaly, an anomaly score, severity/criticality of the anomaly, signature pattern of the anomaly, historical occurrence of the signature patterns near failure or quality downtime events, or combinations thereof for each of the plurality of operational assets to generate the anomaly graph representation.

The asset anomaly representation generator 122 may be configured to generate the anomaly graph representation based on a user-defined format. In this embodiment, the anomaly graph representation is a fishbone cause and effect diagram having a plurality of branches wherein each branch corresponds to a cause for each detected anomaly. Here, the asset anomaly representation generator 122 is configured to dynamically build and update a graph tree view for each detected anomaly in the connected system 102. Further, the individual graph tree view may be expanded for each anomaly to build the network graph for all the operational assets 110, 112 and 114.

Further, the asset anomaly analyzer 124 is configured to analyze the anomaly graph representation to determine one or more anomalies and/or deviating events for the plurality of operational assets 110, 112 and 114 and associated causal inferences for the one or more anomalies and/or deviating events based on the generated anomaly graph representation. The asset anomaly analyzer 124 is configured to identify at least one of a normal state, an anomalous state, a downtime state, a ramp-up state, a ramp-down state, or combinations thereof of the connected system 102.

The asset anomaly representation generator 122 is configured to identify an anomaly patch with a defined start and end time for the assets such as 110, 112 and 114 and to define the location and hierarchy of the respective asset 110, 112 and 114 that generated this anomaly. Further, various causes, can be represented as branches in an anomaly graph. For example, one such cause or branch could be representative of a change in operational states such as a different product type or specification or geometry. A variety of other causes may be envisaged and may be represented as branches for the graphical representation.

The asset anomaly representation generator 122 is further configured to perform a process of elimination and automatically identify if the root cause is found multiple times in the same or different causal trees. The asset anomaly representation generator 122 is configured to dynamically build and update a graph tree view for each anomaly and expand the individual graph tree for each anomaly to build the network graph for all the assets 110, 112 and 114 in the system 102. In this example, the asset anomaly representation generator 122 is further configured to provide causal inferences from the anomaly graph that spans both temporally to form dynamic links and spatially across the production lines to form a connected network view. Such information may be available to a user via the output 108.

While FIG. 1 illustrates and the following provides a detailed description of various components/modules of the system 100, example embodiments are not limited thereto. For example, the above-identified modules of the system 100 may be implemented via one or more processors (e.g., processor 104) where the one or more processor is configured to execute computer readable instructions stored on a memory (e.g., memory 106) to carry out the functionalities of each of the above-identified modules.

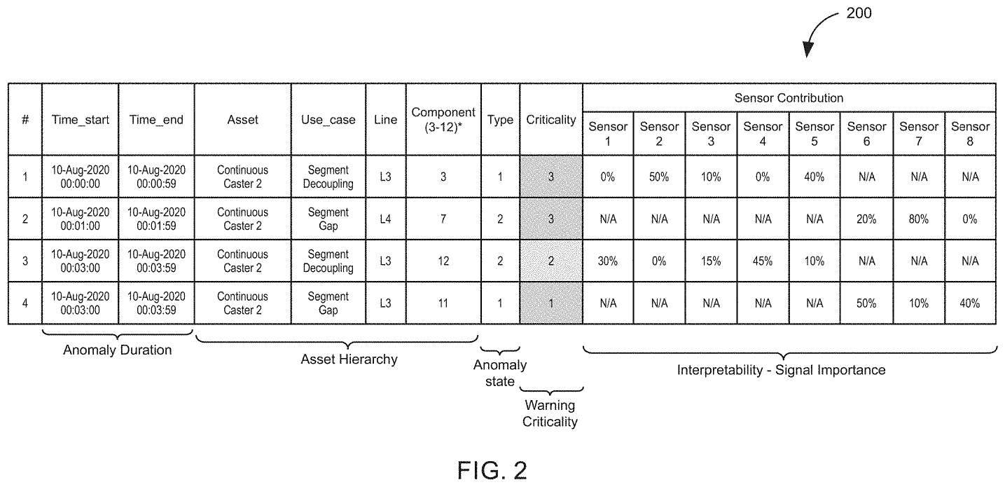

FIG. 2 illustrates an example anomaly detection data chart 200 used by the asset anomaly representation generator 122 to generate the anomaly graph representation for the connected system 102 of FIG. 1. As can be seen, data chart 200 includes details such as asset information, use cases, anomaly states and durations along with warnings criticality and sensor interpretability. Such data is used to generate the anomaly graph representation.

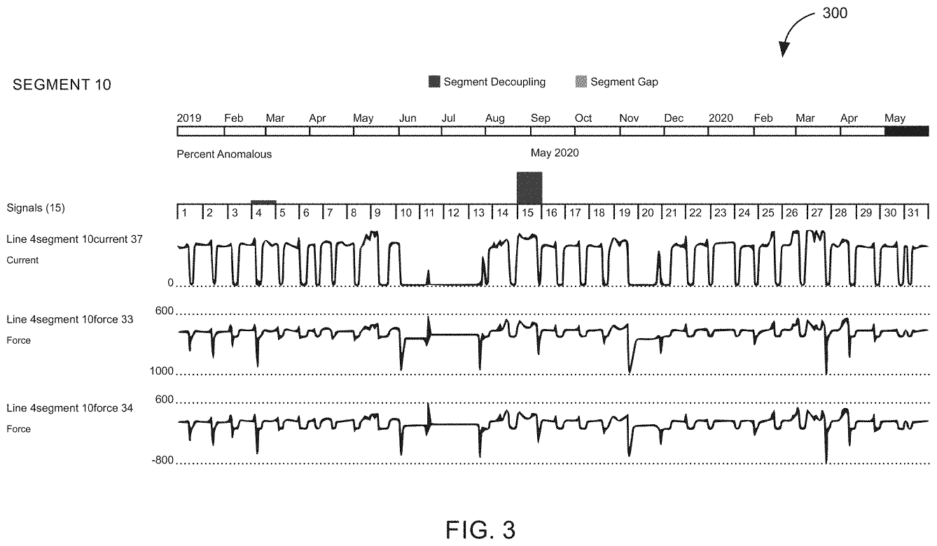

FIG. 3 illustrates example data 300 used by the asset anomaly representation generator 122 to generate the anomaly graph representation for the system 102 of FIG. 1. As illustrated, the example representation 300 shows line segment data received for an asset that is indicative of anomalies in the asset. Such data as described above is used by the asset anomaly representation generator 122 to generate the anomaly graph representation.

In the illustrated embodiment, the data 300 includes time-series signal data measuring the health and performance of an asset called, “segments” comprising of a set of rollers that are driven by a motor through a mechanical coupling. Herein, the purpose of segments is to allow the casted steel slab from a continuous casting process to maintain its geometry and shape without quality defects as it rolls off the production line. In this embodiment, example IoT signal measurements such as, “current measurements that is being drawn by the motor to drive/rotate the rollers” and “force measurements that is being seen at the entrance and exit of the set of rollers as the slab squeezes between them” are illustrated. Here, the x-axis represents time and y-axis represents values of signal measurements. For a specific anomalous patch of time with a defined start to end time as shown in the anomaly data chart 200 of FIG. 2, the behavior of signals in FIG. 3 are studied and statistics such as sensor value change percentages, peak to peak (max-min) change percentages and so forth are computed to populate the anomaly graph representation.

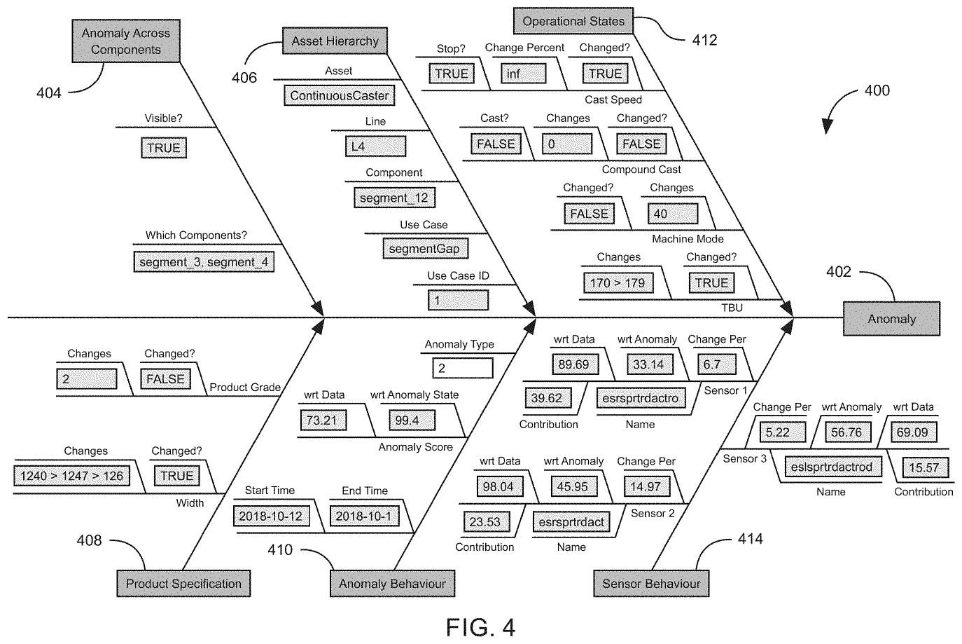

FIG. 4 illustrates an example anomaly graph representation 400 generated by the system 100 of FIG. 1. The asset anomaly representation generator 122 of FIG. 1 is configured to generate a graphical representation such as referred to herein as an anomaly graph 400 that combines data coming from various sources and provides a single view with an analysis of causes of the anomaly. The anomaly graph 400 includes a list of possible causes of the anomaly highlighted with respect to the contribution of the potential cause towards the anomaly.

In the illustrated embodiment, the anomaly graph 400 is populated in the form of a fishbone cause and effect diagram that can be used for an efficient root-cause analysis of events. As can be seen, the anomaly graph 400 includes two parts, the first is effect and the second one includes causes. For example, the effect may be an anomaly 402 such as a wrong product size produced by a manufacturing unit and the latter being branches such as represented by reference numerals 404, 406, 408, 410, 412 and 414 representing possible causes that may have contributed towards the anomaly 402. In this example, the branches may include operational states, anomaly specification, product specification and so forth.

For example, in a manufacturing environment, branch 406 of the anomaly graph 400 may correspond to asset hierarchy that may include details such as asset, line, component, use case, use case ID and so forth. Similarly, branch 410 may correspond to anomaly specification that may include details such as an anomaly type, start time of anomaly, end time of anomaly, duration, an anomaly score and data such as percentile with respect to whole historic data.

Further, branch 412 may correspond to operational states including typical state or status (categorical) signals and non-categorical signals received from sensors. Moreover, branch 408 may correspond to product specification and may include categorical signals about product grades showing change in values or pattern in such product grade value changes. It may also include non-categorical signals with details about product width, for example.

In this example, branch 404 may correspond to anomaly across components within an anomaly window such as trigger for multiple anomalies (True/False), locations and list of components showing anomalous behaviour at same time with configurable overlap window. Further, branch 414 may correspond to sensor behaviour that may include sensor name, sensor contribution, sensor value change percentage, peak to peak change (max-min) change percentage and so forth. In some examples, queries can be made on the individual graphs obtained to get insights into any possibility of dependence among the anomalies observed. It should be noted that the example anomaly graph 400 shown here is for a manufacturing environment and is for illustration purpose only. The branches depicting the causes may change based on the specific environment and the anomalies. The graphical representation 400 such as described above facilitates reduction of unplanned downtime and quality defects performing smart surveillance and rapid forencics on downtime or quality events.

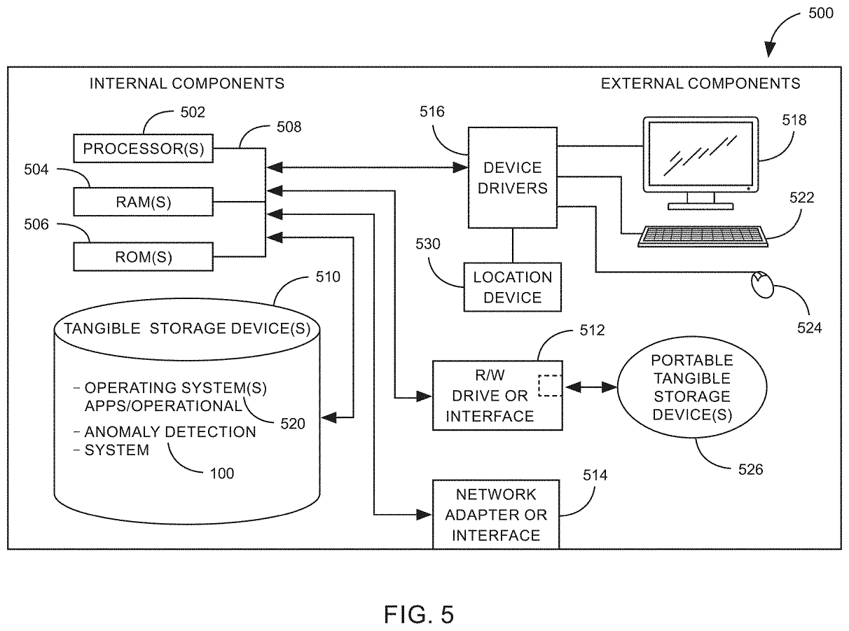

The modules of the anomaly detection system 100 described herein are implemented in computing devices. One example of a computing device 500 is described below in FIG. 5. The computing device includes one or more processor 502, one or more computer-readable RAMs 504 and one or more computer-readable ROMs 506 on one or more buses 508. Further, computing device 500 includes a tangible storage device 510 that may be used to execute operating systems 520 and anomaly detection system 100. The various modules of the anomaly detection system 100 may be stored in tangible storage device 510. Both, the operating system 520 and the system 100 are executed by processor 502 via one or more respective RAMs 504 (which typically include cache memory). The execution of the operating system 520 and/or the system 100 by the processor 502, configures the processor 502 as a special purpose processor configured to carry out the functionalities of the operation system 520 and/or the distributed scale-out storage system 100, as described above.

Examples of storage devices 510 include semiconductor storage devices such as ROM 506, EPROM, flash memory or any other computer-readable tangible storage device that may store a computer program and digital information.

Computing device also includes a R/W drive or interface 514 to read from and write to one or more portable computer-readable tangible storage devices 528 such as a CD-ROM, DVD, memory stick or semiconductor storage device. Further, network adapters or interfaces 512 such as a TCP/IP adapter cards, wireless Wi-Fi interface cards, or 3G or 4G wireless interface cards or other wired or wireless communication links are also included in computing device.

In one example embodiment, the anomaly detection system 100 which includes a processor 104 and a memory 106, may be stored in tangible storage device 510 and may be downloaded from an external computer via a network (for example, the Internet, a local area network or other, wide area network) and network adapter or interface 512.

Computing device further includes device drivers 516 to interface with input and output devices. The input and output devices may include a computer display monitor 518, a keyboard 524, a keypad, a touch screen, a computer mouse 526, and/or some other suitable input device.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A system for cause and effect analysis for unsupervised anomaly detection, comprising:
a memory having computer-readable instructions stored therein;
a processor configured to execute the computer-readable instructions to:
access a connected system having a plurality of production and/or process lines, wherein each of the plurality of production lines comprises a plurality of operational assets;
access scheduling and production data corresponding to a plurality of products manufactured in each of the plurality of production lines, wherein the scheduling and production data comprises product grades and product dimensions;
access sensor data corresponding to each of the plurality of operational assets, wherein the sensor data is indicative of health of each of the plurality of assets;
access asset configuration data and asset anomaly data corresponding to each of the plurality of operational assets,
analyze the sensor data, asset configuration data and asset anomaly data for each of the plurality of operational assets to generate an anomaly graph representation wherein the anomaly graph representation provides a cause and effect analysis view for the connected system; and
determine one or more anomalies and/or deviating events for the plurality of operational assets and associated causal inferences for the one or more anomalies and/or deviating events based on the generated anomaly graph representation.

2. The cause and effect analysis system of claim 1, wherein the processor is configured to execute the computer-readable instructions to generate the anomaly graph representation based upon an asset hierarchy, asset information of the plurality of operational assets, information corresponding to associated process/production lines, production scheduling information corresponding to associated product types, product grades or quality specifications, product geometries, product dimensions or combinations thereof.

3. The cause and effect analysis system of claim 1, wherein the processor is configured to execute the computer-readable instructions to analyze an anomaly type, start and end times of an anomaly, duration of an anomaly, an anomaly score, severity/criticality of the anomaly, signature pattern of the anomaly, historical occurrence of the signature patterns near failure or quality downtime events, or combinations thereof for each of the plurality of operational assets to generate the anomaly graph representation.

4. The cause and effect analysis system of claim 1, wherein the processor is configured to receive at least one of categorical and non-categorical signals from a plurality of sensors of the connected system, wherein the categorical and non-categorical signals are representative of a change trigger, a change percentage or other change values for the operational assets of the system.

5. The cause and effect analysis system of claim 1, wherein the asset configuration data comprises details of specific product type being produced at a specific time, grade and quality specifications of the product type, dimensions or geometry of the product, any change pattern in values of product type, grade or quality specifications, product dimensions, or combinations thereof.

6. The cause and effect analysis system of claim 1, wherein the processor is configured to execute the computer-readable instructions to generate the anomaly graph representation using anomaly detection techniques, unsupervised clustering, network knowledge graphs, dynamic time warping, process flow approaches, or combinations thereof.

7. The cause and effect analysis system of claim 6, wherein the processor is configured to execute the computer-readable instructions to determine and evaluate one or more anomalies in the connected system based upon the anomaly graph representation.

8. The cause and effect analysis system of claim 7, wherein the anomaly graph representation comprises a fishbone cause and effect diagram having a plurality of branches, each branch corresponding to a cause for each detected anomaly.

9. The cause and effect analysis system of claim 8, wherein the processor is configured to execute the computer-readable instructions to:
dynamically build and update a graph tree view for each detected anomaly in the connected system; and
expand the individual graph tree view for each anomaly to build the network graph for all the operational assets.

10. The system of claim 1, wherein the processor is configured to execute the computer-readable instructions to identify at least one of a normal state, an anomalous state, a downtime state, a ramp-up state, a ramp-down state, or combinations thereof.

11. The system of claim 1, wherein the connected system comprises at least one of a manufacturing plant, a mill, an industrial set up, an assembly line, or combinations thereof.

12. A system for cause and effect analysis for unsupervised anomaly detection, comprising:
a memory having computer-readable instructions stored therein;
a processor configured to execute the computer-readable instructions to detect and evaluate one or more anomalies in a connected system with a plurality of operational assets, wherein the processor comprises:
a monitoring system configured to monitor health of the operational assets across a plurality of production and/or process lines via sensor data received from one or more sensors;
an asset data repository configured to store asset configuration data and asset anomaly data corresponding to each of the plurality of operational assets,
an asset anomaly representation generator configured to analyze the sensor data, asset configuration data and asset anomaly data for each of the plurality of operational assets to generate an anomaly graph representation; and
an asset anomaly analyzer configured to analyze the anomaly graph representation to determine one or more anomalies and to identify the root causes and associated causal inferences for the one or more anomalies for each of the operational assets.

13. The cause and effect analysis system of claim 12, wherein the anomaly graph representation comprises a fishbone cause and effect diagram having a plurality of branches, each branch corresponding to causes for each detected anomaly in the system.

14. The cause and effect analysis system of claim 13, wherein the asset anomaly representation generator is configured to:
create a graph tree view for each anomaly with one or more branches indicative of the causes of the respective anomaly;
dynamically update the graph tree view for each anomaly over a period of time; and
generate a network graphical representation for the connected system using the individual graph tree views for each anomaly for the plurality of operational assets.

15. The cause and effect analysis system of claim 14, wherein the asset anomaly analyzer is configured to determine causal inferences from the network graphical representation for the connected system.

16. The cause and effect analysis system of claim 12, wherein the system comprises asset real-time data repository to store sensor data received from the one or more sensors.

17. A method for performing cause and effect analysis for unsupervised anomaly detection, comprising:
accessing a connected system having a plurality of production and/or process lines, wherein each of the plurality of production lines comprises a plurality of operational assets;
receiving sensor data corresponding to each of the plurality of operational assets, wherein the sensor data is indicative of health of each of the plurality of assets;
accessing asset configuration data and asset anomaly data corresponding to each of the plurality of operational assets,
analyzing the sensor data, asset configuration data and asset anomaly data for each of the plurality of operational assets to generate an anomaly graph representation wherein the anomaly graph representation provides a cause and effect analysis view for the connected system; and
determining one or more anomalies and/or deviating events for the plurality of operational assets and associated causal inferences for the one or more anomalies and/or deviating events based on the generated anomaly graph representation.

18. The method of claim 17, comprising:
identifying one or more anomalies with a defined start and end time for the operational assets;
determining a location and hierarchy of the respective asset that generated this anomaly;
establishing one or more various causes for the anomaly, each cause represented as a branch in the anomaly graph representation;
automatically identifying if a root cause is present multiple times in same or different causal trees of the anomaly graph representation;
dynamically building and updating a graph tree view for each anomaly;
expanding the individual graph tree view for each anomaly to build a network graph for the assets in the connected system; and
providing one or more causal inferences from the anomaly graph representation.

19. The method of claim 18, comprising:
determining and evaluating one or more anomalies in the connected system based upon the anomaly graph representation; and
generating one or more warning notifications for the one or more anomalies with the causal inferences.

20. The method of claim 19, comprising predicting one or more downtime and/or anomalous events for a steel mill.
